(19) United States
(12) Patent Application Publication
(10) Pub. No.: US 2026/0333273 A1
(43) Pub. Date: Oct. 22, 2026

(54) METHOD AND APPARATUS FOR MANAGING MOBILE BASE STATION RELAY OPERATION IN WIRELESS NETWORK

(71) Applicant: Samsung Electronics Co., Ltd., Gyeonggi-do (KR)

(72) Inventors: Aman AGARWAL, Bangalore (IN); Avneesh TIWARI, Bangalore (IN); Kailash Kumar JHA, Bangalore (IN); Lalith KUMAR, Bangalore (IN)

(21) Appl. No.: 19/101,433

(22) PCT Filed: Aug. 9, 2023
(86) PCT No.: PCT/KR2023/011783

§ 371 Date: Feb. 5, 2025

(30) Foreign Application Priority Data
Aug. 10, 2022 (IN) 202241045651
Jul. 11, 2023 (IN) 202241045651

(51) Int. Cl. H04W 60/00; H04W 60/04; H04W 88/04

(52) U.S. Cl. CPC H04W 60/001; H04W 60/04; H04W 88/04

(57) ABSTRACT

The disclosure relates to a 5G or 6G communication system for supporting a higher data transmission rate. A method for managing a mobile base station relay (MBSR) operation a user equipment (UE) by a network entity in a wireless network is provided. The method comprises receiving a registration request from the UE for operating as an MBSR; determining whether the UE is allowed to operate as the MBSR based on receiving the registration request from the UE; sending a registration accept message to the UE, based on determining that the UE is not allowed to operate as the MBSR, and the UE being allowed to register in a public land mobile network (PLMN); and sending a registration reject message to the UE, based on determining that the UE is not allowed to operate as the MBSR and the UE being not allowed to register in the PLMN.

### TECHNICAL FIELD

The present disclosure relates to wireless communication networks, and more particularly to managing behaviour of UEs in the wireless communication network, on the UE getting registration accept or reject.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Integrated access and backhaul (IAB) enables wireless in-band and out-of-band relaying of NR Uu access traffic via NR Uu backhaul links. The Uu backhaul links can be links between the IAB-node and a gNB (referred to as an IAB-donor); or another IAB-node. The part of the IAB node that supports the Uu interface towards the IAB-donor or another parent IAB-node (and thus manages the backhaul connectivity with either PLMN or SNPN it is registered with) is referred to as an IAB-UE. FIG. 1 depicts the IAB architecture.

An IAB Node comprises of two modules: IAB-UE and, gNB-DU.

### Mobile Base Station Relay (MBSR) (i.e., a Mobile IAB-Node)

The mobile base station relays (as depicted in FIG. 2) use the IAB architecture. The mobile base station relay has a single hop to the IAB-donor node. The mobile base station relay may serve UEs located inside or outside the vehicle mounted with the relay. The NR Uu is used for the radio link between a mobile base station relay and served UEs, and between the mobile base station relay and the IAB-donor node. The LCS framework is used for providing the location service to the served UEs. The mobile base station may connect to an IAB-donor node of a PLMN or an SNPN.

The 5G system shall support the mobile base station relay (i.e., IAB-node) having a subscription with a HPLMN and roaming from its HPLMN into a VPLMN. In the IAB architecture, a mobile base station relay (i.e., IAB-node) comprises of a gNB-DU and an IAB-UE. For roaming, the IAB-UE behaves as a UE, and thus, may be able to access a VPLMN and reuse UE procedures. However, to support the gNB-DU component of the mobile base station to operate properly in the VPLMN, additional support may need to be defined. Further, whether and how to support the controlling of a mobile base station relay, e.g., enable/disable mobile relay operation if the relay is roaming in a VPLMN needs to be defined. When MBSR roaming is supported, a roaming agreement between the VPLMN and the HPLMN regarding MBSR operation is in place. The AMF can make use of the subscription data for authorization of the MBSR in the V-PLMN.

### PLMN Selection as per 23.122 Without RPLMN

The MS selects and attempts registration on any PLMN/access technology combinations, if available and allowable, in the following order:
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

### PLMN Selection as per 23.122 With RPLMN

The MS selects and attempts registration on any PLMN/access technology combinations, if available and allowable, in the following order:
either the RPLMN or the Last registered PLMN;
either the HPLMN (if the EHPLMN list is not present or is empty) or the highest priority EHPLMN that is available (if the EHPLMN list is present);
each PLMN/access technology combination in the “User Controlled PLMN Selector with Access Technology” data file in the SIM (in priority order);
each PLMN/access technology combination in the “Operator Controlled PLMN Selector with Access Technology” data file in the SIM (in priority order) or stored in the ME (in priority order);
other PLMN/access technology combinations with received high quality signal in random order; and
other PLMN/access technology combinations in order of decreasing signal quality.

A UE can behave as an MBSR (i.e., mobile IAB node), when the UE, optionally, provides an mobile IAB-indication to the IAB-donor-CU or includes an MBSR indication to the Network Entity (to the gNodeB/NG-RAN as a part of AN (Access Network) parameters or to the AMF as a part of the Registration procedure) during the RRC connection establishment and on the basis of the subscription data for IAB operation, the selected AMF (by the IAB-donor-CU), optionally, performs the IAB authorization during the UE registration procedure/UE context setup procedure/modification procedure. However, a UE can behave either as a normal UE/UE (No MBSR)/UE (without mobile relay operation) or as a UE (with mobile relay operation)/UE (MBSR)/MBSR using the MBSR authorization on the basis of subscription data of the UE. As per existing methods/procedures, when a UE performs registration or attempts to register to the Network in any area/location or PLMN (for example, roaming area or HPLMN or VPLMN or any PLMN) as a UE (with mobile relay operation)/UE (MBSR)/as MBSR, optionally, using the mobile IAB authorization, either,

The AMF may accept the Registration Request of the mobile base station relay; or

The AMF may reject the Registration Request of the mobile base station relay with a 5GMM cause value indicating that the mobile base station relay is not allowed to operate as a relay in the selected/current area or UE location or any roaming area or in the current time or in the serving PLMN or HPLMN or VPLMN or the selected/camped/registered/current serving PLMN.

Consider a case of Registration reject or any AS/NAS signalling indicating a reject message from the AMF or the Network or any Network entity, for the UE with a 5GMM cause value indicating that the UE is not allowed to operate as a Mobile Base Station Relay in the VPLMN area or any roaming area or any selected/camped/registered PLMN. In such a case, it is not defined and is not clear as to how the UE can register with the Network if the UE still wants to register as a normal UE, optionally in the same area/location or in the same serving PLMN or a different PLMN. In order to register with the network as a normal UE (without mobile relay operation)/UE (No-MBSR), if the UE has to again send a registration request or any AS/NAS signalling to the Network/AMF/any Network function, this may unnecessarily increase the signalling overload between the UE and the Network/AMF/Network Entity for the UE to get registered with the Network/AMF/Network Entity for a normal UE (without mobile relay operation)/UE (No-MBSR) services and may also lead to delay in getting service (normal or MBSR service) for the UE. This is depicted in FIG. 3.

Referring to FIG. 3, at step 301, UE 402 sends a registration request for an MBSR to an NG-RAN 401A for initiating a registration procedure as the MBSR. NG-RAN 401A sends an N2 message including a mobile IAB or MBSR indication to an AMF 401B, based on receiving the registration request for the MBSR. At step 303, an MBSR authorization is performed between the AMF 402B and a UDM 402C, based on the AMF receiving the N2 message. At step 304, the AMF 402B sends a registration reject with 5GMM cause indicating that the MBSR is not allowed to operate as a relay in the current serving PLMN to the UE 402, based on the MBSR authorization. At step 305, the UE 402 may have to again send a registration request to the network (e.g. the AMF 402B). This will increase the signalling overload between the UE and the network for the UE to get registered with the network for normal UE/UE (No-MBSR) services.

Also, after the Registration reject from the AMF/any Network Function/entity or NG-RAN, for the mobile base station relay with a 5GMM cause value indicating that the mobile base station relay is not allowed to operate as a relay in the current UE location/area or any roaming area or in the current time or in the current serving PLMN or any selected/camped/registered PLMN, the UE's behaviour is not specified in any existing literature/document/procedure.

### DISCLOSURE OF INVENTION

### Solution to Problem

The principal object of the embodiments herein is to disclose methods and systems for managing behaviour of UEs in the wireless communication network, on the UE getting registration accept or reject.

According to an embodiment of the present disclosure, a method for managing a mobile base station relay (MBSR) operation a user equipment (UE) by a network entity in a wireless network is provided. The method may comprise receiving a registration request from the UE for operating as an MBSR; determining whether the UE is allowed to operate as the MBSR based on receiving the registration request from the UE; sending a registration accept message to the UE, based on determining that the UE is not allowed to operate as the MBSR, and the UE being allowed to register in a public land mobile network (PLMN); and sending a registration reject message to the UE, based on determining that the UE is not allowed to operate as the MBSR and the UE being not allowed to register in the PLMN.

According to an embodiment of the present disclosure, an apparatus of a network entity in a wireless network is provided. The apparatus may comprise a transceiver; and a processor coupled to the transceiver. The processor may be configured to receive a registration request from a user equipment (UE) for operating as a mobile base station relay (MBSR); determine whether the UE is allowed to operate as the MBSR, based on receiving the registration request from the UE; send a registration accept message to the UE, based on determining that the UE is not allowed to operate as the MBSR and the UE being allowed to register in a public land mobile network (PLMN); and send a registration reject message to the UE, based on determining that the UE is not allowed to operate as the MBSR and the UE being not allowed to register in the PLMN.

According to an embodiment of the present disclosure, a method for a mobile base station relay (MBSR) operation by user equipment (UE) in a wireless network is provided. The method may comprise sending a registration request to a network entity for operating as the MBSR; receiving a registration accept message from the network entity based on the UE being not allowed to operate as the MBSR and being allowed to register in a public land mobile network (PLMN); and receiving a registration reject message from the network entity based on the UE being not allowed to operate as the MBSR and being not allowed to register with the PLMN.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIG. 1 depicts the IAB architecture, according to related arts;

FIG. 2 depicts MBSR, according to related arts;

FIG. 3 depicts UE behaviour, on getting registration accept or reject, according to related arts;

FIG. 4 depicts a communication network, comprising one or more network entities and one or more UEs, according to embodiments as disclosed herein;

FIG. 5 depicts an example scenario, wherein one or more UEs are connected to the network entity, according to embodiments as disclosed herein;

FIG. 6 shows various hardware components of the network entity, according to embodiments as disclosed herein;

FIG. 7 is a flowchart depicting the behaviour of the UE on receiving a registration accept message, according to embodiments as disclosed herein;

FIG. 8 depicts an example behaviour of the UE on receiving a registration accept message, according to embodiments as disclosed herein;

FIG. 9 depicts the behaviour of the UE on receiving a registration reject message, according to embodiments as disclosed herein; and

FIG. 10 depicts a scenario, wherein the UE is not allowed to act as a MBSR, according to embodiments as disclosed herein.

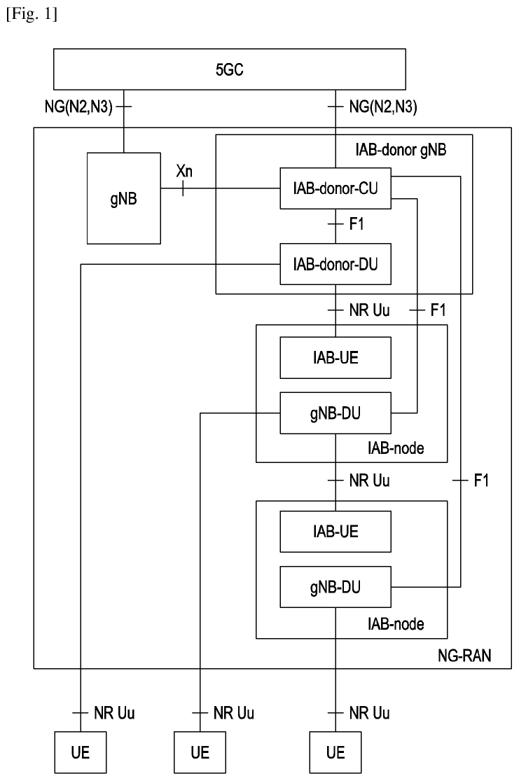

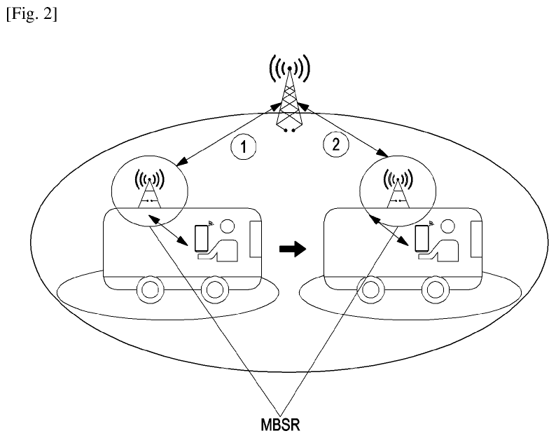

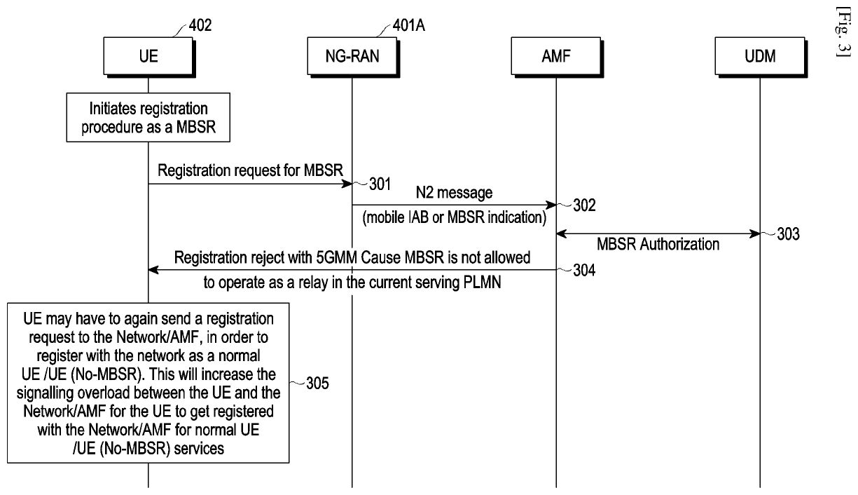

### MODE FOR THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

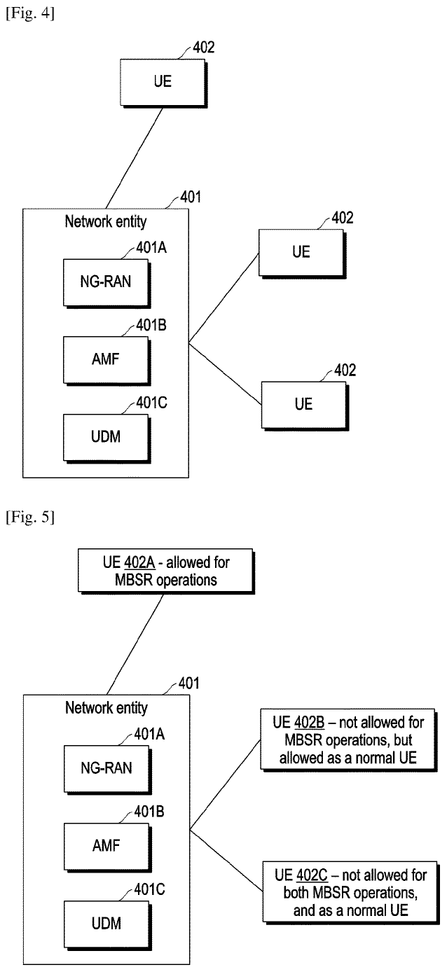

The embodiments herein achieve methods and systems for managing behaviour of UEs in the wireless communication network, on the UE getting registration accept or reject. Referring now to the drawings, and more particularly to FIGS. 4 through 10, where similar reference characters denote corresponding features consistently throughout the figures, there are shown example embodiments.

The following abbreviations and definitions have been referred to herein:
NTN: Non Terrestrial Networks
TN: Terrestrial Network
AS: Access Stratum
NAS: Non-Access Stratum
MS: Mobile Station
UE: User Equipment
ME: Mobile Equipment
USIM: Universal Subscriber Identity Module
gNB: Next generation Node-B (gNode-B)
gNB-DU: Next generation Node-B Distributive Unit
gNB-CU: Next generation Node-B Control Unit
SNPN: Stand-alone Non-Public Network
NR: New Radio
5GC: 5G Core
NW: Network
IAB: Integrated access and backhaul
IAB-UE: The part of the IAB node that supports the Uu interface towards the IAB-donor or another parent IAB-node (and thus manages the backhaul connectivity with either PLMN or SNPN it is registered with) is referred to as an IAB-UE.
NG-RAN: Next Generation Radio Access Network
NR: New Radio
MBSR: Mobile Base Station Relay
PLMN: Public Land Mobile Network
RPLMN: Registered Public Land Mobile Network
HPLMN: Home Public Land Mobile Network
VPLMN: Visited Public Land Mobile Network
FPLMN: Forbidden Public Land Mobile Network
PLMN ID: Public Land Mobile Network Identity
UCU: UE Configuration Update
UPU: UE Policy Update
LCS: Location services
5GMM: 5G Mobility Management
5GS: 5G System
AUSF: Authentication Server Function
eNB: Evolved Node-B
EPS: Evolved Packet System
EPC: Evolved Packet Core
EPLMN: Equivalent Public Land Mobile Network
E-UTRA: Evolved Universal Mobile Telecommunication Access
E-UTRAN: Evolved Universal Mobile Telecommunication Access Network
MME: Mobility Management Entity
NB-S1 mode: Narrow Band with S1 Interface
NW: Network
PLMN ID: Public Land Mobile Network Identity
RRC: Radio Resource Control
SIM: Subscriber Identity Module
USIM: Universal Subscriber Identification Module
Uu: The radio interface between the UE and the Node B
VMR: Vehicle Mounted Relay
VPLMN: Visited Public Land Mobile Network
WB-S1 Mode: Wide Band with S1 Interface
AMF: Access and Mobility Management Function
3GPP: Third Generation Partnership Project

Satellite: an artificial body placed in orbit round the earth or moon or another planet in order to collect information or for communication.
Satellite Constellation: A group of satellites, placed in orbit round the earth or moon or another planet in order to collect information or for communication.
Service User: An individual who has received a priority level assignment from a regional/national authority (i.e., an agency authorized to issue priority assignments) and has a subscription to a mobile network operator.
Visited PLMN (VPLMN): This is a PLMN different from the HPLMN (if the EHPLMN list is not present or is empty) or different from an EHPLMN (if the EHPLMN list is present).
Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
Available PLMN: PLMN(s) in the given area which is/are broadcasting capability to provide wireless communication services to the UE.
Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
EHPLMN: Any of the PLMN entries contained in the Equivalent HPLMN list.
Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.
Home PLMN: This is a PLMN where the MCC and MNC of the PLMN identity match the MCC and MNC of the IMSI.
Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.
Registration: This is the process of camping on a cell of the PLMN or the SNPN and doing any necessary LRs.
UPLMN: PLMN/access technology combination in the “User Controlled PLMN Selector with Access Technology” data file in the SIM (in priority order).
OPLMN: PLMN/access technology combination in the “Operator Controlled PLMN Selector with Access Technology” data file in the SIM (in priority order) or stored in the ME (in priority order).

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command; UE PARAMETERS UPDATE command and so on.

The term 5GMM sublayer states as disclosed herein can be at least one of the below:
5GMM-NULL
5GMM-DEREGISTERED
5GMM-DEREGISTERED.NORMAL-SERVICE
5GMM-DEREGISTERED.LIMITED-SERVICE
5GMM-DEREGISTERED.ATTEMPTING-REGISTRATION
5GMM-DEREGISTERED.PLMN-SEARCH
5GMM-DEREGISTERED.NO-SUPI
5GMM-DEREGISTERED.NO-CELL-AVAILABLE
5GMM-DEREGISTERED.eCALL-INACTIVE
5GMM-DEREGISTERED.INITIAL-REGISTRATION-NEEDED
5GMM-REGISTERED-INITIATED
5GMM-REGISTERED
5GMM-REGISTERED.NORMAL-SERVICE
5GMM-REGISTERED.NON-ALLOWED-SERVICE
5GMM-REGISTERED.ATTEMPTING-REGISTRATION-UPDATE
5GMM-REGISTERED.LIMITED-SERVICE
5GMM-REGISTERED.PLMN-SEARCH
5GMM-REGISTERED.NO-CELL-AVAILABLE
5GMM-REGISTERED.UPDATE-NEEDED
5GMM-DEREGISTERED-INITIATED
5GMM-SERVICE-REQUEST-INITIATED

the term EMM sublayer states as referred to herein can be at least one of the below:
EMM-NULL
EMM-DEREGISTERED
EMM-DEREGISTERED.NORMAL-SERVICE
EMM-DEREGISTERED.LIMITED-SERVICE
EMM-DEREGISTERED.ATTEMPTING-TO-ATTACH
EMM-DEREGISTERED.PLMN-SEARCH
EMM-DEREGISTERED.NO-IMSI
EMM-DEREGISTERED.ATTACH-NEEDED
EMM-DEREGISTERED.NO-CELL-AVAILABLE
EMM-DEREGISTERED.eCALL-INACTIVE
EMM-REGISTERED-INITIATED
EMM-REGISTERED
EMM-REGISTERED.NORMAL-SERVICE
EMM-REGISTERED.ATTEMPTING-TO-UPDATE
EMM-REGISTERED.LIMITED-SERVICE
EMM-REGISTERED.PLMN-SEARCH
EMM-REGISTERED.UPDATE-NEEDED
EMM-REGISTERED.NO-CELL-AVAILABLE
EMM-REGISTERED.ATTEMPTING-TO-UPDATE-MM
EMM-REGISTERED.IMSI-DETACH-INITIATED
EMM-DEREGISTERED-INITIATED
EMM-TRACKING-AREA-UPDATING-INITIATED
EMM-SERVICE-REQUEST-INITIATED

The term RAT as referred to herein can be at least one of the following: NG-RAN, 5G, 4G, 3G, 2G, EPS, 5GS, NR, NR in unlicensed bands, NR(LEO) satellite access, NR(MEO) satellite access, NR(GEO) satellite access, NR (OTHERSAT) satellite access, NR RedCap, E-UTRA, E-UTRA in unlicensed bands, NB-IoT, WB-IoT, LTE-M, and so on.

The terms mobile base station relay, IAB-Node, relay node, MBSR, UE (with mobile relay operation), UE (MBSR) and UE (with Mobile Base Station Relay (MBSR) operation) are used interchangeably and have the same meaning. These terms refer to the UE which has the mobile IAB-node Capability and may function as a MBSR or the UE as a relay node.

The terms normal UE, UE (NO-MBSR), UE (without mobile relay operation) and UE (without MBSR operation) are used interchangeably and have the same meaning. These terms refer to the UE which may or may not have the IAB-node capability and does not function as a MBSR or doesn't function as the UE with a relay node.

The terms camp and register are used interchangeably and have the same meaning.

The term area as used in this embodiment may refer to any of cell/cell ID, TAC/TAI, PLMN, MCC/MNC or combination of MCC and MNC, latitude/longitude, or any geo-graphical location/coordinate.

The solutions explained in this embodiment are applicable to any (but not limited to) of the RAT(s) as defined in this embodiment.

The Network used in this embodiment could be any 5G/EUTRAN Core Network Entities like AMF/SMF/MME/UPF or the Network could be any (but not limited to) 5G/EUTRAN RAN Entity like eNodeB (eNB) or gNodeB (gNB) or NG-RAN etc.

The solutions which are defined for NR (5GC) can also be applicable to legacy RATs like E-UTRA/LTE, the corresponding CN entities needs to be replaced by LTE entities for e.g. AMF with MME, g-nodeB with e-nodeB, UDM with HSS etc. But principles of the solution remains same.

The Network used in this embodiment is explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc.

The messages used or indicated in this embodiment are shown as an example. The messages could be any signalling messages between UE and the Network Functions/Entities or between different Network functions/entities.

The methods, issues or solutions disclosed in this embodiment are explained using NR access or NG-RAN Access Technology as an example and is not restricted or limited to NR access only. However, the solutions proposed in this embodiment are also applicable for E-UTRAN access Technology, NB (Narrow Band)-S1 mode or WB (Wide Band)-S1 mode via E-UTRAN access and/or NB-IOT (NarrowBand Internet Of Things) or WB-IOT (WideBand Internet Of Things) Access/Architecture.

For the list of possible NAS messages please refer to 3GPP TS 24.501 or 3GPP TS 24.301, for list of AS messages please refer to 3GPP TS 38.331 or 3GPP TS 36.331

The cause names in this embodiment are for illustration purpose and it can have any name. The non access stratum (NAS) messages and access stratum (AS) messages described in this embodiment is only for illustration purpose it can be any NAS or AS messages as per defined protocol between UE and AMF/MME or UE and gNB (NG-RAN/any RAN node)/eNB.

Embodiments herein define a method for a UE to determine if the UE can operate as a normal UE (i.e., without MBSR or relay capabilities) without the need of triggering a registration procedure again for the same selected/registered/current serving PLMN. When a MBSR or IAB-UE triggers a registration procedure with the serving PLMN and indicates its request to operate as a MBSR, the network entity (such as AMF/UDM/NG-RAN or any other Network entity/function) of the serving PLMN authorizes, based on subscription information or current UE location or current time, whether the UE is allowed to operate as a MBSR or not. If the AMF or any Network Function/Entity (AMF is considered as an example of the network function/entity and is not limited to, the AMF) of the serving PLMN determines that the UE is not allowed to operate as a MBSR UE in the serving PLMN, as a part of registration procedure or any signaling message/procedure, then the network entity indicates the following to the UE:
The network entity indicates to the UE (for example, using MBSR Authorization information/indication; i.e., MBSR authorization indication (not authorized)) in the REGISTRATION ACCEPT message that the UE is allowed to be registered in the current serving PLMN, but UE is not allowed to act as a MBSR (i.e., UE can register as a normal UE and not as a MBSR)
The network entity indicates to the UE (for example, using MBSR Authorization information/indication MBSR authorization indication (not authorized)) in the REGISTRATION REJECT message that the UE is not allowed to be registered in the current serving PLMN (i.e., the UE is not allowed to operate as a normal UE and the UE is not allowed to act as a MBSR in the current serving PLMN).

FIG. 4 depicts a communication network, comprising one or more network entities and one or more UEs. The network 400, as depicted, comprises one or more network entities 401, and one or more UEs 402. The one or more network entities 401 can be a NG-RAN 401A, an AMF 401B, and a Unified Data Management (UDM) 401C. The network entity 401 can further comprise an Authentication Server Function (AUSF), a gNB, and so on (not shown), wherein these entities may perform one or more of the functions of the NG-RAN 401A, the AMF 401B, the UDM 401C, and the VPLMN AMF 401D.

Consider that a UE 402 performs registration or attempts to register to the network 400 (using at least one of a AS or NAS signalling message) in any area/location or any roaming area or any PLMN or HPLMN or any VPLMN or on any selected/camped/registered/serving PLMN as a UE 402 (with Mobile Base Station Relay (MBSR) operation)/UE (MBSR) or if the UE performs Handover or performs any mobility registration procedure (for example, with 5GS Registration Type “mobility registration updating” etc.), optionally using the mobile IAB authorization or MBSR indication, if the Network or the network entity 401 determines that the UE is not allowed to operate as a MBSR in the selected or camped or current serving PLMN, then the network entity 401 can indicate to the UE 402 that the UE is not allowed to operate as a MBSR in the selected or camped or current serving PLMN. In an embodiment herein, the network entity 401 can indicate to the UE 402 in any Information Element (IE) or indication such as MBSR Authorization information/indication (MBSR Authorization indication (not authorized)) in the REGISTRATION ACCEPT message indicating “MBSR (UE with mobile base station relay operation) not allowed and/or the UE may operate only as a normal UE (UE without mobile base station relay operation) only”. In an example herein, the network entity 401 can indicate to the UE 402 in a 5GS Registration Result IE in the REGISTRATION ACCEPT message indicating “MBSR (UE with mobile base station relay operation) not allowed and/or the UE may operate only as a normal UE (UE without mobile base station relay operation) only”.

In an embodiment herein, the network entity 401 can indicate the area/PLMN/TAI/geographical location where the UE 402 is not allowed to operate as MBSR and may operate only as a normal UE. In an embodiment herein, the network entity 401 can indicate to the UE 402 in an IE in the REGISTRATION ACCEPT message indicating “MBSR (UE with mobile base station relay operation) not allowed and/or the UE 402 may operate only as a normal UE (UE without mobile base station relay operation) only in the current area/location or in the current/given PLMN area or any area or for the current time or in the VPLMN or in any of the selected/ camped/registered/current serving PLMN”. In an example herein, the network entity 401 can indicate to the UE in the 5GS Registration Result IE in the REGISTRATION ACCEPT message indicating “MBSR (UE with mobile base station relay operation) not allowed and/or the UE may operate only as a normal UE (UE without mobile base station relay operation) only in the VPLMN/PLMN area or any area/location/time or in the VPLMN/any PLMN or the selected/camped/registered/current serving PLMN”.

The indicated/included IE/indication (for example, MBSR Authorization information/indication), by the network entity 401 to the UE 402, shall indicate whether the UE 402 is allowed for MBSR operations (optionally both as MBSR as well as a normal UE) or whether the UE 402 is not allowed to operate as a MBSR the UE shall operate as a normal UE only (i.e., as a UE 402 without MBSR operation).

If the IE, included in the Registration Accept message, indicates “UE is allowed for MBSR operations (optionally both as MBSR as well as a normal UE)”, the UE 402 shall remain registered with the selected network 400 or PLMN and may operate as MBSR UE, optionally in the current/given location/time. In an embodiment herein, the UE 402 may remain registered with the selected/current serving/registered network 400 and may operate as a MBSR UE only in the area/PLMN, optionally indicated by the network 400. Optionally, The UE shall indicate MBSR indication or ability to operate as MBSR to the AS layers or to the NG-RAN or to other Network entities. In yet another embodiment, the UE shall indicate MBSR supported indication to the lower layers or the Network entities for any subsequent registration procedure or any signaling procedure for the current serving/registered PLMN, optionally if present in the same location/allowed time period.

If the UE 402 moves out of the area/PLMN, optionally indicated by the Network 400, the UE 402 shall either de-register from the Network 400 and start PLMN-selection or PLMN-search procedure or the UE 402 shall trigger any mobility related procedure to either camp as a Normal UE (i.e., the UE shall not indicate MBSR indication or ability to operate as MBSR to the AS layers or to the NG-RAN or to other Network entities) or a UE with the MBSR capability (UE-MBSR) (i.e., the UE shall indicate MBSR indication or ability to operate as MBSR to the AS layers or to the NG-RAN or to other Network entities). Optionally, the UE may provide the MBSR Authorization indication/information (i.e., MBSR authorization indication (authorized) to the lower layers.

The UE 402 may optionally store/update the area/PLMN/TAI/geographical location and/or time along with the entry of the PLMN/Access technology combinations, if optionally the area/PLMN/TAI/geographical location or time is explicitly indicated by the Network where/when the UE is not allowed to register for mobile relay operations or for normal services along with mobile relay operations or implicitly the UE understands that the area/PLMN/TAI/geographical location or time is not allowed to operate as MBSR with the appropriate reject/accept cause/IE.

If the IE, included in the Registration Accept message, indicates “UE is allowed to operate as a normal UE only (i.e., UE without mobile base station relay operation)” or “UE is not allowed to operate as a UE with MBSR”, the UE 402 shall remain registered with the selected/current serving/registered Network 400 and shall operate as a normal UE only and shall not operate as MBSR UE for the selected or registered PLMN. Optionally, the UE 402 may remain registered with the selected/current serving/registered network 400 and may operate as a normal UE only in the area/ time/PLMN, optionally indicated by the network 400. Optionally, The UE shall not indicate MBSR indication or ability to operate as MBSR to the AS layers or to the NG-RAN or to other Network entities. Optionally, the UE may provide the MBSR Authorization indication/information (i.e., MBSR authorization indication (not authorized) to the lower layers. In yet another embodiment, the UE shall not indicate MBSR supported indication or shall indicate MBSR Not supported indication to the lower layers or the Network entities for any subsequent registration procedure or any signaling procedure for the current serving/registered PLMN, optionally if present in the same location/allowed time period.

If the UE 402 moves out of the area/time/PLMN, optionally indicated by the network 400, the UE 402 shall either de-register from the network 400 and start PLMN-selection or PLMN-search procedure or the UE 402 shall trigger any mobility related procedure to either camp as a normal UE or a UE 402 with MBSR capability (UE-MBSR).

In an embodiment herein, the network 400 may not include any IE in the Registration Accept message to indicate that the UE is allowed for MBSR operations (either as a MBSR and/or a normal UE), if the network 400 determines that the UE 402 is allowed to operate as a MBSR in the selected or camped or current serving PLMN or optionally, in the camped/selected area/time. The network 400 shall only include the IE in the Registration Accept message to indicate that the “UE is allowed to operate as a normal UE only (i.e., UE without MBSR operation)” or “UE is not allowed to operate as a UE with MBSR”, if the network 400 determines that the UE is not allowed to operate as a MBSR in the selected or camped or current serving or registered PLMN or in the camped/selected area/time.

FIG. 5 depicts an example scenario, wherein one or more UEs 402 are connected to the network entity 401. In the depicted example scenario, a first UE 402A that has been allowed for MBSR operations (optionally both as MBSR as well as a normal UE); a second UE 402B that has been allowed to operate as a normal UE only (i.e., as a UE 402 without MBSR operation); and a third UE 402C that has not been allowed to operate as a normal UE or for MBSR operations.

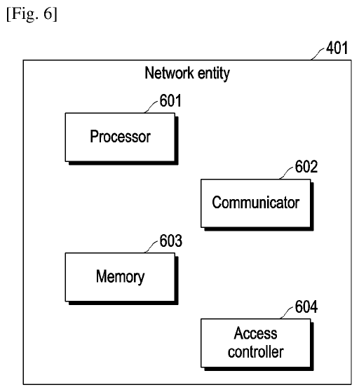

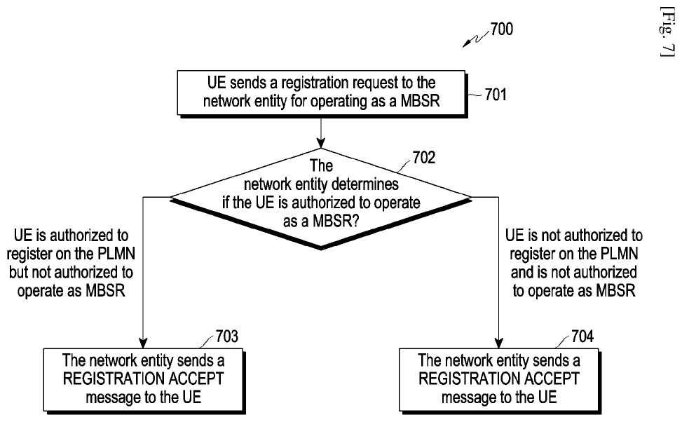

FIG. 6 shows various hardware components of the network entity 401, according to the embodiments as disclosed herein. In an embodiment, the network entity 401 includes a processor 601, a communicator 602, a memory 603, and an access controller 604. The processor 601 can be coupled with the communication 602, the memory 602, and the access controller 604.

The access controller 604 can be implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor 601 can be configured to execute instructions stored in the memory 603 and to perform various processes. The processor 601 may comprise at least one processor. In an aspect, the processor 601 and the access controller 604 may be integrally referred to as at least one processor. The processor 601 may control overall operation of the network entity 401. Thus, the operations of the network entity 401 may be understood as being executed substantially by the processor 601. The communicator 602 configured for communicating internally between internal hardware components and with external devices via one or more networks. The communicator 602 may be referred to as a transceiver. The memory 603 can also store instructions to be executed by the processor 601. The memory 603 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 603 may, in some examples, be considered a non-transitory storage medium. The term “non-transitory” may indicate that the storage medium is not embodied in a carrier wave or a propagated signal. However, the term “non-transitory” should not be interpreted that the memory 603 is non-movable. In certain examples, a non-transitory storage medium may store data that can, over time, change (e.g., in Random Access Memory (RAM) or cache).

Consider that the access controller 604 receives a registration request from the UE 402 (using at least one of a AS or NAS signalling message). The access controller 604 can check if the UE 402 is allowed/not allowed to operate as a MBSR and/or a normal UE. If the access controller 604 determines that the UE 402 is not allowed to operate as a MBSR in the selected or camped or current serving/registered PLMN, optionally in the current UE location/time, then the access controller 604 can indicate to the UE 402 (for example, using any of the IE/indication such as MBSR authorization information/indication (MBSR authorization indication(not authorized)) that the UE is not allowed to operate as a MBSR in the selected or camped or current serving/registered PLMN. In an embodiment herein, the access controller 604 can indicate to the UE 402 in any IE/indication (for example, using any of the IE/indication such as MBSR authorization information/indication (MBSR authorization indication(not authorized)) in the REGISTRATION ACCEPT message indicating “MBSR (UE with mobile base station relay operation) not allowed and/or the UE may operate only as a normal UE (UE without mobile base station relay operation) only”. In an example herein, the access controller 604 can indicate to the UE 402 in a 5GS Registration Result IE in the REGISTRATION ACCEPT message indicating “MBSR (UE with mobile base station relay operation) not allowed and/or the UE may operate only as a normal UE (UE without mobile base station relay operation) only”.

In an embodiment herein, the access controller 604 can indicate the area/ PLMN/TAI/geographical location or time where the UE 402 is not allowed to operate as MBSR and may operate only as a normal UE. In an embodiment herein, the access controller 604 can indicate to the UE 402 in an IE in the REGISTRATION ACCEPT message indicating “MBSR (UE with mobile base station relay operation) not allowed and/or the UE 402 may operate only as a normal UE (UE without mobile base station relay operation) only in the current location/time or in the VPLMN area or any area or in the VPLMN/any PLMN or the selected/camped/registered PLMN”. In an example herein, the access controller 604 can indicate to the UE in the 5GS Registration Result IE in the REGISTRATION ACCEPT message indicating “MBSR (UE with mobile base station relay operation) not allowed and/or the UE may operate only as a normal UE (UE without mobile base station relay operation) only in the VPLMN area or any area or in the VPLMN or the selected/camped/registered PLMN”.

In the indicated/included IE/indication (for example, using any of the IE/indication such as MBSR authorization information/indication), the access controller 604 can indicate to the UE 402, whether the UE 402 is allowed for MBSR operations (optionally both as MBSR as well as a normal UE) or whether the UE 402 shall operate as a normal UE only (i.e., as a UE 402 without MBSR operation).

In an embodiment herein, the access controller 604 may not include any IE in the Registration Accept message to indicate that the UE is allowed for MBSR operations (either as a MBSR and/or a normal UE), if the access controller 604 determines that the UE 402 is allowed to operate as a MBSR in the selected or camped PLMN or in the camped/selected area/location/time. The access controller 604 shall only include the IE in the Registration Accept message to indicate that the “UE is allowed to operate as a normal UE only (i.e., UE without MBSR operation)” or “UE is not allowed to operate as a UE with MBSR”, if the access controller 604 determines that the UE is not allowed to operate as a MBSR in the selected or camped PLMN or in the camped/selected area.

Although the FIG. 6 shows various hardware components of the network entity 401, but it is to be understood that other embodiments are not limited thereon. In other embodiments, the network entity 401 may include less or a greater number of components. Further, the labels or names of the components are used only for illustrative purpose and does not limit the scope of the invention. One or more components can be combined together to perform same or substantially similar function in the network entity 401.

The UE 402 can comprise at least one processor, a communicator, and a memory like the network entity. The description of the processor 601, communication 602, and the of the network entity 401 memory 603 can be also applied to the at least one processor, the communicator, and the memory of the UE 402.

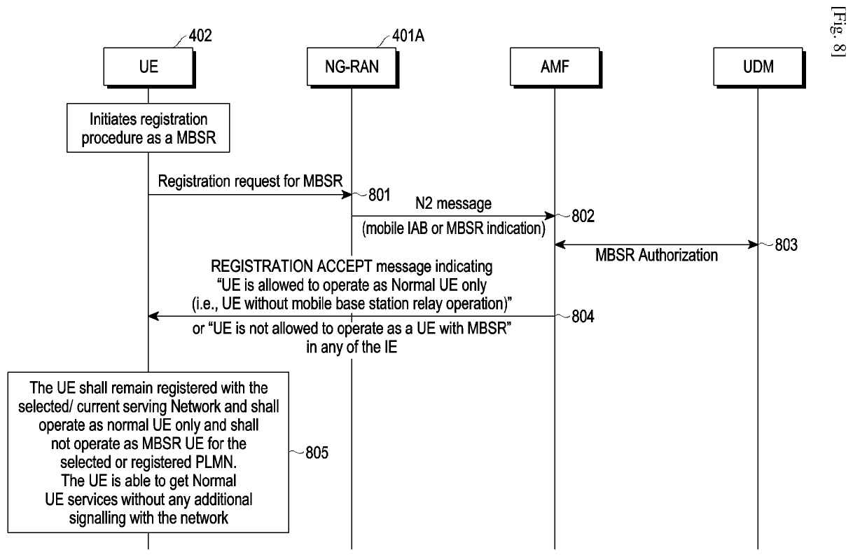

FIG. 7 is a flowchart depicting the behaviour of the UE on receiving a registration accept message. In step 701, the UE 402 sends a registration request to the network entity 401 for operating as a Mobile Base Station Relay (MBSR) optionally using any indication (for example, MBSR indication). On receiving the registration request from the UE 402, in step 702, the network entity 401 determines if the UE is allowed/authorized to operate as a MBSR. The network entity 401 can determine if the UE is allowed/authorized to operate as the MBSR based on at least one of subscription information, time, and a location of the UE. Time as referred to herein can be the allowed/authorized time vs the current time. If the current time is within the range of allowed time operation, UE would be allowed to operate as the MBSR. Location as referred to herein can be the allowed/authorized location vs the current location. If the current location is within the area of allowed/authorized location, the UE would be allowed to operate as the MBSR. In step 703, the network entity 401 sends a REGISTRATION ACCEPT message to the UE 402, on determining that the UE 402 is allowed/authorized to register with a Public Land Mobile Network (PLMN), but is not allowed/authorized to operate as the MBSR. In an embodiment herein, the REGISTRATION ACCEPT message comprises the IE/indication (for example, using any of the IE/indication such as MBSR authorization information/indication (MBSR authorization indication(not allowed/authorized)), wherein the IE/indication indicates that the UE is not allowed/authorized to operate as the MBSR, optionally in the current serving/registered PLMN, optionally in the current UE location/time. In an embodiment herein, the REGISTRATION ACCEPT message may optionally comprise a Fifth Generation (5G) Mobility Management (5GMM) cause value, optionally to indicate UE is not allowed to operate as a MBSR. In step 704, the network entity 401 sends a REGISTRATION REJECT message to the UE 402, on determining that the UE 402 is not allowed/authorized to register with the PLMN and is not allowed/authorized to operate as the MBSR. In an embodiment herein, the REGISTRATION REJECT message to the UE comprises an IE/indication (for example, using any of the IE/indication such as MBSR authorization information/indication (MBSR authorization indication (not allowed/authorized)), wherein the IE/indication indicates that the UE is not allowed/authorized to operate as the MBSR, optionally in the current serving/registered PLMN, optionally in the current UE location/time. In an embodiment herein, the REGISTRATION REJECT message to the UE comprises a 5GMM cause value optionally, which can be used to indicate that the UE is not allowed to operate as a MBSR and/or the UE is not allowed to register to the current serving/registered PLMN, optionally in the current UE location/time. The various actions in method 700 may be performed in the order presented, in a different order or simultaneously. Further, in some embodiments, some actions listed in FIG. 7 may be omitted.

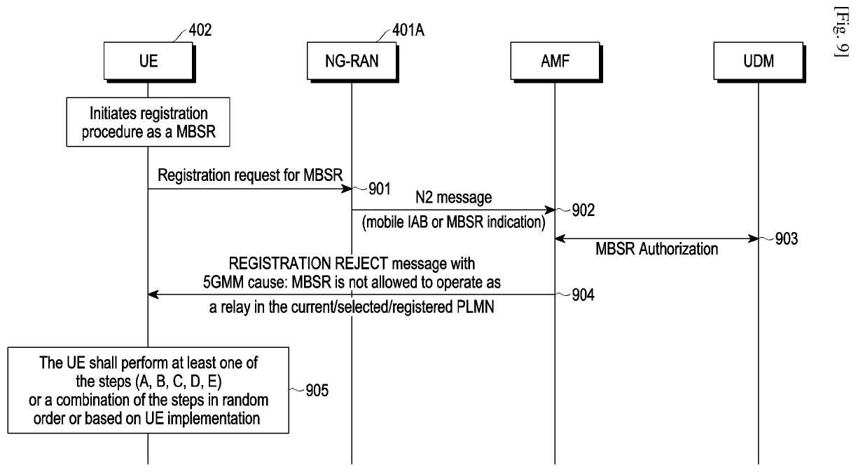

FIG. 8 depicts an example behaviour of the UE on receiving a registration accept message. In step 801, the mobile base station relay (UE with mobile base station relay operation) 402 initiates a registration procedure or any signaling (AS/NAS signaling) procedure/message and indicates its intention to operate as a MBSR (provides MBSR indication) to the lower layers or to the Network Entities in RRC connection or any AS/NAS signaling message to the NG-RAN 401A. In step 802, the NG-RAN 401A may optionally include the UE's Capability to operate as a MBSR or MBSR indication in any of the message/parameter in an indication to the AMF 401B. In an example, the intention of the UE 402 to operate as a MBSR may be indicated by the NG-RAN 401A in N2 parameters to the 401B. In step 803, the AMF 401B may optionally perform the MBSR authorization (mobile IAB-authorization) for the UE 402 with the UDM 401C or any other Network function/entities, optionally based on subscription, location, or time. The AMF 401B may determine whether the UE 402 is allowed to operate as a MBSR in the selected or camped or current serving/registered PLMN or in the selected/camped area/UE location/time or not. In step 804, if the AMF 401B determines that the UE is not allowed to operate as a MBSR in the selected or camped or current serving/registered PLMN or optionally in the selected/camped area or optionally, the current location or time, the AMF 401B shall indicate to the UE 402 in the REGISTRATION ACCEPT message indicating indicates “UE is allowed to operate as a normal UE only (i.e., UE without MBSR operation)” or “UE is not allowed to operate as a UE with MBSR” in any of the IE (for example, 5GS Registration Result IE) or indication (for example, using any of the IE/indication such as MBSR authorization information/indication (MBSR authorization indication (not authorized)). Optionally, the AMF 401B may indicate to the NG-RAN 401A that the UE 402 is not allowed to operate as a relay or as a MBSR in the selected/current serving/registered PLMN or optionally in the selected area/location/time and the NG-RAN 401A may indicate the same to the UE 402. In step 805, the UE 402 shall remain registered with the selected/registered network/PLMN/RAT and shall operate as a normal UE only and shall not operate as MBSR UE for the selected or registered PLMN or optionally in the selected/camped area/location/time.

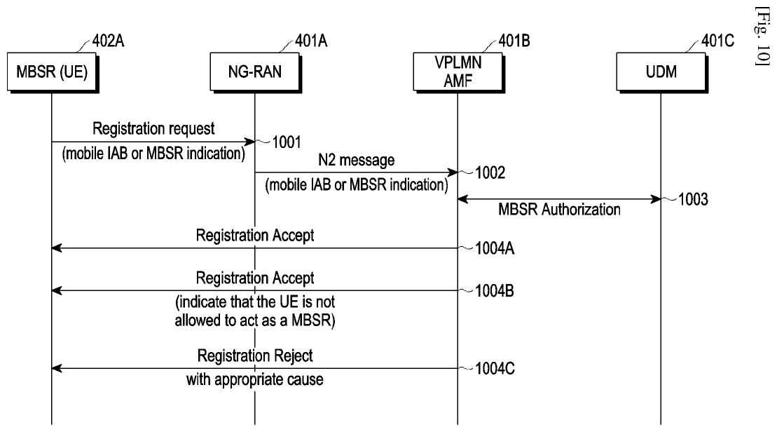

FIG. 9 depicts the behaviour of the UE on receiving a registration reject message. In step 901, the mobile base station relay (UE with mobile base station relay operation) 402 initiates a registration procedure or any signaling message/procedure(any AS/NAS signaling message) and indicates its intention to operate as a MBSR (provides MBSR indication) to the lower layers or to the Network Entities in RRC connection or any AS/NAS signaling message to the NG-RAN 401A. In step 902, the NG-RAN 401A may optionally include the UE's Capability to operate as a MBSR or MBSR indication in any of the message/parameter in an indication to the AMF 401B. In an example, the intention of the UE 402 to operate as a MBSR may be indicated by the NG-RAN 401A in N2 parameters to the 401B. In step 903, the AMF 401B may optionally perform the MBSR authorization (mobile IAB-authorization) for the UE 402 with the UDM 401C or any other Network function/entities, optionally based on subscription, location, or time. The AMF 401B may determine whether the UE 402 is allowed to operate as a MBSR in the selected or camped or current serving/registered PLMN or optionally in the selected/camped area/location or time or not. If the UE 402 is not allowed to operate as a MBSR in the selected or camped or current serving/registered PLMN or optionally in the selected/camped area or in the location or time or not, in step 904, the AMF 401B may reject the Registration Request of the mobile base station relay with an IE or indication (for example, using any of the IE/indication such as MBSR authorization information/indication (MBSR authorization indication(not authorized)) and/or with a 5GMM cause value indicating that the UE 402 is not allowed to operate as a relay in the current serving PLMN area or any roaming area or on the selected/registered PLMN or for the current time/location. When the UE 402 receives the Reject from the Network 400 (via any AS or NAS signalling message), the UE 402 shall attempt to register/perform registration using a UE registration procedure (via any AS or NAS signalling message) with the same or the selected/registered/current serving Network/PLMN or with a different Network/PLMN as a normal UE (No MBSR/without mobile relay operation) without MBSR indication to the lower layers or to the Network entities, optionally in the same area or in the different area. In an embodiment herein, the UE 402 shall trigger a PLMN Search or PLMN Selection on any other PLMN/access technology combinations, if available and allowable, for MBSR services only as a MBSR UE (with mobile relay operation or MBSR) in the same area or the different area with the same Network/RAT/PLMN or combination of these or with the different Network/RAT/PLMN or combination of these. In an embodiment, the UE 402 may perform PLMN Search/PLMN Selection to prioritize MBSR services over normal services in the same area or the different area with the same/different Network/RAT/PLMN or their combination. If the UE 402 finds any suitable PLMN/access technology combinations, the UE 402 shall initiate a registration procedure (via any AS or NAS signalling message) to register as a MBSR UE/with MBSR indication. In an embodiment, If the UE 402 finds any suitable PLMN/access technology combinations, the UE 402 shall initiate a registration procedure (via any AS or NAS signalling message) to register as a normal UE without MBSR operations/without MBSR indication. In step 905, the UE 402 shall perform at-least one of the below steps (A, B, C, D, E), in any possible combination (in a random order or based on UE implementation), in the same area/PLMN or a different area/ PLMN:
The UE 402 shall trigger a registration procedure to the network on the same or any other RAT/PLMN/access technology combinations, if available and allowable for normal services only as a normal UE (without mobile relay operation or NO MBSR) or without MBSR indication to the lower layers and/or to the Network entities. In an embodiment herein, the UE shall trigger a registration procedure to the network on any other RAT/PLMN/access technology combinations, if available and allowable for mobile base station relay services only as a MBSR UE (with mobile relay operation or MBSR) with MBSR indication to the lower layers and/or to the Network entities or for both Normal along with MBSR services.
The UE 402 shall set the GMM state to 5GMM-REGISTERED with substate AT-TEMPTING-REGISTRATION-UPDATE and set the 5GS update status to 5U2 NOT UPDATED or any of the 5GMM sublayer states or any of the EMM sublayer states defined in this embodiment. The UE 402 shall stay in the current serving cell and apply normal cell selection or cell reselection process. In an embodiment herein, the UE 402 shall set the GMM state to 5GMM-REGISTERED with substate PLMN-SEARCH and perform PLMN Selection procedure. In an embodiment herein, the UE 402 shall set the GMM state to 5GMM-REGISTERED with substate UPDATE-NEEDED and perform cell selection/reselection procedure. In an embodiment, the UE 402 may initiate registration procedure as a normal UE (without indicating MBSR capability without MBSR indication to the lower layers and/or to the Network entities) in the current serving cell. In an embodiment, the UE 402 may initiate registration procedure as a MBSR UE (with indicating MBSR capability with MBSR indication to the lower layers and/or to the Network entities) in the selected/camped cell.
The UE 402 shall set the GMM state to 5GMM-DEREGISTERED with substate ATTEMPTING-REGISTRATION and set the 5GS update status to 5U2 NOT UPDATED. The UE 402 shall initiate registration procedure. In an embodiment herein, the UE 402 shall set the GMM state to 5GMM-DEREGISTERED with substate PLMN-SEARCH and perform PLMN Selection procedure. In an embodiment, the UE 402 may initiate registration procedure as a NORMAL UE (without indicating MBSR capability without MBSR indication to the lower layers and/or to the Network entities) in the current serving cell. In an embodiment, the UE 402 may initiate registration procedure as a MBSR UE (with indicating MBSR capability with MBSR indication to the lower layers and/or to the Network entities) in the selected/camped cell.
The UE 402 shall trigger/perform the PLMN selection procedure as per “PLMN selection as per 23.122 without RPLMN” or “PLMN selection as per 23.122 with RPLMN” to select and attempt registration on the same or other PLMN/access technology combinations, if available and allowable, for normal services only, as a normal UE (without mobile relay operation or NO MBSR).
The UE 402 shall trigger/perform the PLMN selection procedure as per “PLMN selection as per 23.122 without RPLMN” or “PLMN selection as per 23.122 with RPLMN” to select and attempt registration on any other PLMN/access technology combinations, if available and allowable, for MBSR services only, as a mobile base station relay (UE with mobile relay operation or MBSR).

FIG. 10 depicts a scenario, wherein the UE is not allowed to act as a MBSR. The UE 402 triggers the registration procedure when entering in a roaming area following the existing procedures. The registration message can indicate support for MBSR indication (or mobile IAB indication). Based on local policy or based on subscription information received from the UDM 401C, the VPLMN AMF 401B determines if the UE is allowed to act as a MBSR. The UDM 401C provides the MBSR allowed indication to the AMF 401B as part of the Access and Mobility Subscription data as defined in clause 4.2.2.2.2 of TS 23.502. If the UE 402 is allowed to act as MBSR, a registration accept is provided to the UE 402, and the UE 402 can act as MBSR. In an embodiment herein, if the UE 402 is not allowed to act as MBSR, but allowed to receive normal services, a Registration accept is provided to the UE 402 by including an indication (for example, using any of the IE/indication such as MBSR authorization information/indication (MBSR authorization indication(not authorized)) that it is not allowed to act as MBSR; for example, in 5GS registration result IE. The UE 402 shall not act as MBSR in this case. Optionally, the UE may provide the MBSR Authorization indication/information (MBSR authorization indication (not authorized) to the lower layers/AS layer. Optionally, The UE shall not indicate MBSR indication or ability to operate as MBSR to the AS layers or to the NG-RAN or to other Network entities. In yet another embodiment, the UE shall not indicate MBSR supported indication or shall indicate MBSR Not supported indication to the lower layers or the Network entities for any subsequent registration procedure or any signaling procedure for the current serving/registered PLMN, optionally if present in the same location/ allowed time period. Additionally, the AMF 401B may include the list of TAIs where the UE 402 is not allowed to act as MBSR. The UE 402 adds this TAIs in list of forbidden TAI for MBSR. In an embodiment herein, if the UE 402 is not allowed to act as MBSR and the UE is not allowed to register on the current serving PLMN, the AMF 401B may choose to provide a registration reject message with an appropriate cause (for example, 5GMM Reject cause). The UE 402 will add current TAI in list of forbidden TAI for MBSR. If the UE 402 is allowed to receive normal service it may trigger an initial registration procedure without indicating support for MBSR (or IAB indication). The UE 402 will not indicate support for MBSR (i.e., will not act as MBSR) when it is camped on a TAI which is part of forbidden TAI for MBSR. The granularity of the forbidden lists can be at TAI level, or it can be at PLMN level which can be decided during evaluation/conclusion phase.

In step 1001, the UE 402 triggers the registration procedure when entering in a roaming area following the existing procedures. The registration message or signaling message can indicate support for MBSR (or mobile IAB indication) or MBSR indication. In step 1002, the NG-RAN 401A forwards the MBSR-indication in a N2 message along with the Registration Request message as per existing procedure to the VPLMN AMF 401B. In step 1003, the VPLMN AMF 401B performs UE authentication and registration and further checks with the UDM 401C or any other Network entities. The UDM 401C provides the MBSR allowed/not allowed indication to the AMF 401B, as part of the Access and Mobility Subscription data as defined in clause 4.2.2.2.2 of TS 23.502. In step 1004A, if the AMF 401B determines that the UE 402 is authorized to operate as a MBSR, the AMF 401B sends a MBSR authorized indication/information (MBSR Authorized indication(authorized)) to the NG-RAN 401A and a Registration Accept message to the UE 402. In step 1004B, if the AMF 401B determines that the UE 402 is not authorized to operate as a MBSR and the UE 402 is allowed to receive normal services, the AMF 401B sends a MBSR not authorized indication/information (MBSR Authorized indication(not authorized)) to the NG-RAN 401A and a Registration Accept message to the UE 402 and indicates (for example, in 5GS Registration result IE or any other IE/indication such as MBSR authorization information) that the UE 402 is not allowed to act as MBSR. The UE 402 shall not act as a MBSR in this case. Additionally, the AMF 401B may include the list of TAIs where the UE 402 is not allowed to act as the MBSR. The UE 402 adds these TAIs in a list of forbidden TAI for MBSR. In step 1004C, if the UE 402 is not allowed to act as MBSR, the AMF 401B may choose to provide a registration reject message with an appropriate 5GMM cause value and may also send a MBSR not authorized indication/ information (MBSR Authorized indication(not authorized)). The UE 402 will add the current TAI to the list of forbidden TAI for MBSR. If the UE is allowed to receive normal service, it may trigger initial registration procedure without indicating support for MBSR (or IAB indication), optionally for the current serving/registered PLMN, optionally, in the current location/time. The UE 402 will not indicate support for MBSR (i.e., will not act as MBSR) when its camped on a TAI which is part of the forbidden TAI for MBSR. The granularity of these forbidden lists can be at TAI level, or it can be at PLMN level which can be decided during evaluation/conclusion phase.

The embodiments disclosed herein can be implemented through at least one software program running on at least one hardware device and performing network management functions to control the elements. The elements shown in FIGS. 4, 5, and 6, may be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the scope of the embodiments as described herein.

1. A method for managing a mobile base station relay (MBSR) operation a user equipment (UE) by a network entity in a wireless network, the method comprising:
receiving a registration request from the UE for operating as an MBSR;
determining whether the UE is allowed to operate as the MBSR based on receiving the registration request from the UE;
sending a registration accept message to the UE, based on determining that the UE is not allowed to operate as the MBSR, and the UE being allowed to register in a public land mobile network (PLMN); and
sending a registration reject message to the UE, based on determining that the UE is not allowed to operate as the MBSR and the UE being not allowed to register in the PLMN.

2. The method of claim 1, further comprising:
determining whether the UE is allowed to operate as the MBSR based on subscription information of the UE.

3. The method of claim 1, wherein the registration accept message comprises:
an indication indicating that the UE is not allowed to operate as the MBSR.

4. The method of claim 1, wherein the registration reject message comprises:
an indication indicating that the UE is not allowed to operate as the MBSR.

5. The method of claim 1, wherein based on receiving the registration accept message, the UE remains registered to a current serving PLMN as a normal UE.

6. The method of claim 1, wherein based on receiving the registration reject message, the UE attempts to trigger at least one of a PLMN search and a PLMN selection procedure.

7. An apparatus of a network entity in a wireless network, the apparatus comprising:
a transceiver; and
a processor coupled to the transceiver, wherein the processor is configured to:
receive a registration request from a user equipment (UE) for operating as a mobile base station relay (MBSR);
determine whether the UE is allowed to operate as the MBSR, based on receiving the registration request from the UE;
send a registration accept message to the UE, based on determining that the UE is not allowed to operate as the MBSR and the UE being allowed to register in a public land mobile network (PLMN); and
send a registration reject message to the UE, based on determining that the UE is not allowed to operate as the MBSR and the UE being not allowed to register in the PLMN.

8. The apparatus of claim 7, wherein the processor is further configured to:
determine whether the UE is authorized to operate as the MBSR based on subscription information of the UE.

9. The apparatus of claim 7, wherein the registration accept message comprises:
an indication indicating that the UE is not allowed to operate as the MBSR.

10. The apparatus of claim 7, wherein the registration reject message comprises:
an indication indicating that the UE is not allowed to operate as the MBSR.

11. A method for a mobile base station relay (MBSR) operation by user equipment (UE) in a wireless network, the method comprising:
sending a registration request to a network entity for operating as the MBSR;
receiving a registration accept message from the network entity based on the UE being not allowed to operate as the MBSR and being allowed to register in a public land mobile network (PLMN); and
receiving a registration reject message from the network entity based on the UE being not allowed to operate as the MBSR and being not allowed to register with the PLMN.

12. The method of claim 11, wherein whether the UE is allowed to operate as the MBSR is determined based on subscription information of the UE.

13. The method of claim 11, wherein the registration accept message comprises:
an indication indicating that the UE is not allowed to operate as the MBSR.

14. The method of claim 11, wherein the registration reject message comprises:
an indication indicating that the UE is not allowed to operate as the MBSR.

15. The method of claim 11, further comprising:
based on receiving the registration accept message, remaining registered to a current serving PLMN as a normal UE.
